(19) United States
(12) Patent Application Publication
(10) Pub. No.: US 2013/0039085 A1
(43) Pub. Date: Feb. 14, 2013

(54) VEHICLE LIGHTING DEVICE

(71) Applicants: Kazunori Iwasaki, Isehara-shi (JP); Kei Onoma, Isehara-shi (JP)

(72) Inventors: Kazunori Iwasaki, Isehara-shi (JP); Kei Onoma, Isehara-shi (JP)

(73) Assignee: ICHIKOH INDUSTRIES, LTD.

(21) Appl. No.: 13/561,295

(22) Filed: Jul. 30, 2012

(30) Foreign Application Priority Data
Aug. 9, 2011 (JP) 2011-174363

(51) Int. Cl. B60Q 1/04; F21V 13/04

(52) U.S. Cl. 362/516

(57) ABSTRACT

A vehicle lighting device is provided in such a manner that a reflector and a light source are incorporated in a lamp room made of a housing and a front lens. The light source is disposed so that an emission direction of light from a light emission surface of the light source crosses an optical axis of the front lens. The reflector is disposed on one side with respect to a surface on which the light source is to be disposed, the reflector being configured with a curved portion that is adapted to reflect the light from the light source to a side of the front lens. A coloring member is disposed so as to be adjacent to at least a part of the periphery of the light emission surface of the light source.

### CROSS-REFERENCE TO RELATED APPLICATIONS

This application claims priority of Japanese Patent Application No. 2011-174363 filed on Aug. 9, 2011. The contents of this application are incorporated herein by reference in their entirety.

### BACKGROUND OF THE INVENTION

1. Field of the Invention

The present invention is directed to a vehicle lighting device, and relates to a vehicle lighting device that is employed in a lamp such as a headlamp, for example.

2. Description of the Related Art

A headlamp, for example, of a vehicle has entailed an inconvenience that at daytime when the headlamp is not lit, in a case where the headlamp is seen from a slightly front upper side of a vehicle, the inside of a lamp room is seen dark, resulting in impairment of an appearance of the headlamp.

Therefore, as disclosed in Japanese Unexamined Patent Application Publication No. 2000-076510, Japanese Unexamined Patent Application Publication No. 2006-310048, and Japanese Unexamined Patent Application Publication No. 2008-204903, there is known a technique of applying a color such as a bright color to a light shading plate or the like that is adapted to shade a fraction of light that is emitted from a light source via a reflector and then eliminate the light having been upwardly emitted, thereby eliminating the inconvenience described above.

However, the vehicle lighting devices disclosed in Japanese Unexamined Patent Application Publication No. 2000-076510, Japanese Unexamined Patent Application Publication No. 2006-310048, and Japanese Unexamined Patent Application Publication No. 2008-204903 mentioned above have been those of a so-called projector type, and have been those adapted to provide a light shading plate between a reflector and a focusing lens.

Accordingly, in a vehicle lighting device that is not provided with a light shading plate, it has been difficult to apply the technique disclosed in Japanese Unexamined Patent Application Publication No. 2000-076510, Japanese Unexamined Patent Application Publication No. 2006-310048, and Japanese Unexamined Patent Application Publication No. 2008-204903.

In this case, it is also contemplated to dispose a plate member in which a bright color is applied to a site that is equivalent to a portion at which the light shading plate is to be disposed; and however, the disposition of such a plate member becomes not preferable because a fraction of the light from a light source is shaded by means of the plate member, causing a decrease in quantity of emission of the light from the vehicle lighting device.

### SUMMARY OF THE INVENTION

The present invention has been made in view of the circumstance as described above, and it is an object of the present invention to provide a vehicle lighting device with its improved appearance by exhibiting a predetermined color in the periphery of a light source when it is not lit.

The vehicle lighting device according to the present invention is provided in such a manner that: a reflector is disposed without being directly opposed to a front portion of a lamp room of a light source (on a front lens side that defines the lamp room), and is disposed so as to reflect light from the light source to the front lens side with respect to a surface on which the light source is to be disposed; and further, a coloring member is caused to be adjacent to at least a part of the periphery of a light emission surface of the light source. In other words, the coloring member is disposed in a location in which the light from the light source is not shaded.

(1) A vehicle lighting device according to first aspect the present invention, includes a reflector and a light source that are incorporated in a lamp room made of a housing and a front lens, in which the light source is disposed so that an emission direction of light from a light emission surface of the light source crosses an optical axis of the front lens, the reflector is disposed on one side with respect to a surface on which the light source is to be disposed, the reflector being configured with a curved portion that is adapted to reflect the light from the light source to a side of the front lens, and a coloring member is disposed so as to be adjacent to at least a part of a periphery of the light emission surface of the light source.

(2) In the vehicle lighting device according to the first aspect of the present invention, in the first aspect, the light source is disposed upward of the reflector in a state in which the vehicle lighting device is mounted on a vehicle, and the coloring member is disposed so as to be adjacent to the side of the front lens with respect to at least the light emission surface of the light source.

(3) In the vehicle lighting device according to the first aspect of the present invention, the light source is disposed downward of the reflector in a state in which the vehicle lighting device is mounted on a vehicle, and the coloring member is disposed so as to be adjacent to an opposite side of the front lens with respect to at least the light emission surface of the light source.

According to the vehicle lighting device thus provided, a predetermined color is exhibited in the periphery of a light source when it is not lit, without any problem such as shading light from the light source, thereby making it possible to improve an appearance of the device.

### BRIEF DESCRIPTION OF THE DRAWINGS

FIG. 1 is a view showing essential portions of a vehicle lighting device according to a first embodiment of the present invention, and is also a sectional view taken along the line I-I of FIG. 3;

FIG. 2 is a sectional view showing the essential portions of the vehicle lighting device according to the first embodiment of the present invention;

FIG. 3 is a perspective view when a reflector that is disposed in a lamp room is seen from a front lens side in the vehicle lighting device according to the first embodiment of the present invention;

FIG. 4 is a sectional view schematically showing a vehicle lighting device according to a second embodiment of the present invention;

FIG. 5 is a perspective view when a reflector that is disposed in a lamp room is seen from a front lens side in the vehicle lighting device according to the second embodiment of the present invention; and

FIG. 6 is a sectional view showing the essential portions of the vehicle lighting device according to the second embodiment of the present invention.

### DESCRIPTION OF THE PREFERRED EMBODIMENTS

Hereinafter, the preferred embodiments of the present invention (hereinafter, simply referred to as “the embodiments”) will be described in detail with reference to the accompanying drawings. It is to be noted that throughout the description of the embodiments, same constituent elements are designated by same reference numerals.

### First Embodiment

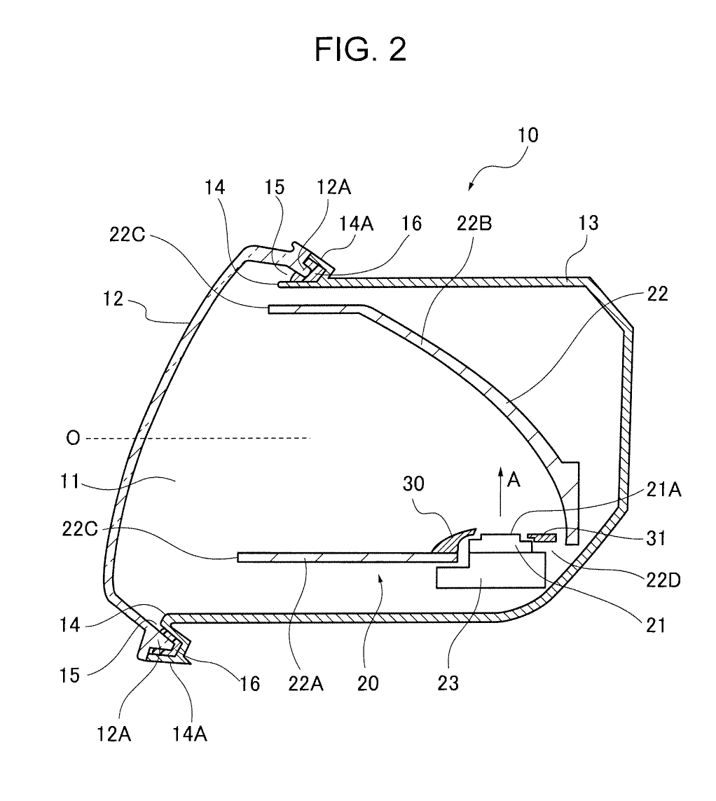

FIG. 2 is a sectional view schematically showing a vehicle lighting device according to a first embodiment of the present invention. FIG. 2 shows a vehicle lighting device 10 made of a headlamp, for example.

In FIG. 2, the vehicle lighting device 10 is provided in such a manner that a lamp room 11 thereof is defined by a front lens 12 and a housing 13. The front lens 12 is disposed on the front side of a vehicle (on the left side in the figure), and the housing 13 is disposed on the back side of the vehicle (on the right side in the figure).

The housing 13 has an opening 14 in a front portion of the vehicle, and in an opening edge 14A thereof, a groove portion 15 is formed for inserting a circumferential edge portion 12A of the front lens 12. A sealing member 16 is applied to the groove portion 15 of the opening edge 14A of the housing 13, and by means of this sealing member 16, the circumferential edge portion 12A of the front lens 12 is securely fixed, and a sealing property of preventing entry of moisture can be ensured.

A headlamp 20 is arranged in the lamp room of the vehicle lighting device 10. This headlamp 20 is substantially made of a light emitting element 21 and a reflector 22.

The light emitting element 21 is formed in the shape of a pallet, and on a surface of the light emitting element 21, a light emission surface 21A is formed and configured. It is to be noted that this light emitting element 21 is mounted in a heat sink 23 that is fixed to the housing 13 so as to be disposed in the lamp room 11. The heat sink 23 is adapted to dissipate a heat that is generated while the light emitting element 21 is driven. The light emitting element 21 is disposed downward of the lamp room 11 so that the light emission surface 21A is oriented upward of the lamp room 11. In other words, the light emitting element 21 is disposed so that an emission direction (as indicated by the arrow A in the figure) of the light from the light emission surface 21A crosses an optical axis (as indicated by the dotted line O in the figure) of the front lens 12 without the light emission surface 21A being directly opposed to the front lens 12.

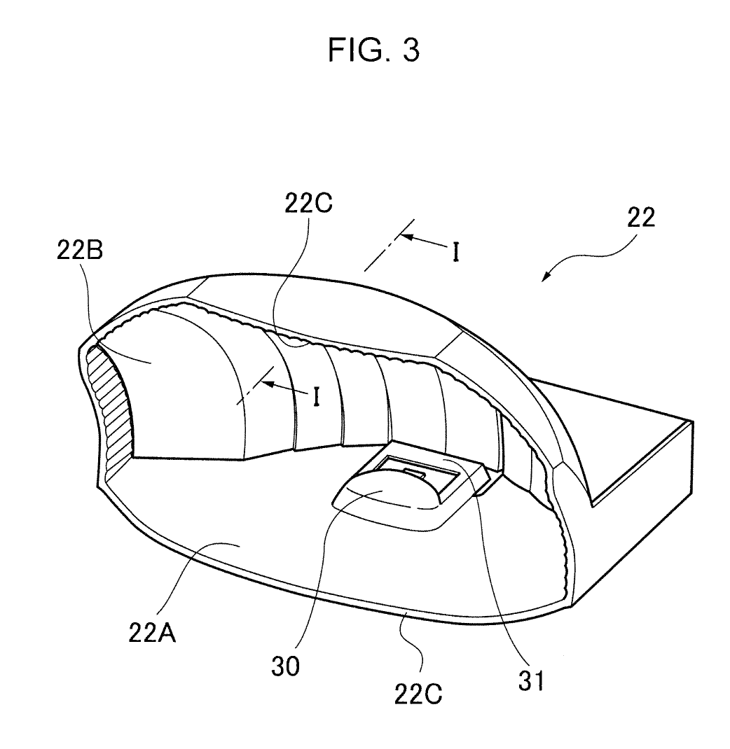

The reflector 22 has: a flat portion 22A that is substantially flush with a surface on which the light emitting element 21 is to be disposed (which is equivalent to a mount surface of the heat sink 23); and a curved portion 22B that is formed on an upper side with respect to the surface on which the light emitting element 21 is to be disposed, and an opening 22C is formed and configured on the side of the front lens 12. FIG. 3 is a perspective view when the reflector 22 is seen from the side of the front lens 12, and it becomes evident that the reflector 22 is configured with the flat portion 22A and the curved portion 22B so as to be formed in the shape of a container having the opening 22C.

Turning to FIG. 2, an opening portion 22D that is adapted to expose the light emitting element 21 is provided at a site at which the light emitting element 21 is to be disposed, on the flat portion 22A of the reflector 22. In this manner, after the light emitting element 21A has been fixed to the housing 13 via the heat sink 23, the reflector 22 is fixed to the housing 13, thereby making it possible to dispose the light emitting element 21 at a predetermined site with respect to the reflector 22.

The curved portion 22B of the reflector 22 has a free surface that is obtained by combining a rotational parabola surface and a parabolic columnar surface or the like with each other, for example, and is configured with a light reflection surface that is obtained by applying light reflection processing to an interior face of an opposite side of the light emitting element 21. The curved portion 22B of the reflector 22 has a function of reflecting the light from the light emission surface 21A of the light emitting element 21 on the light reflection surface and then emitting the reflected light to the side of the front lens 12.

In the flat portion 22A of the reflector 22, a shade 30 and a coloring member 31 made of a material such as a resin or a metal, for example, are mounted and provided at the periphery of the opening portion 22D in which the light emitting element 21 is to be disposed. The shade 30 is provided forward of the light emitting element 21 (on the side of the front lens 12), and is formed so as to cover the periphery of the light emitting element 21 up to a site just before reaching the light emission surface 21A. This shade 30 functions as a shading member so that in a case where the lamp room 11 of the vehicle lighting device 10 is seen through the front lens 12, the light emitting element 21 or its related wiring connected to the light emitting element 21 or the like is not directly visually seen. The coloring member 31 is formed integrally with the shade 30, for example, and is provided at a respective one of the side potions and the backside portion of the light emitting element 21 (on the opposite side of the front lens 12). In this case, an area of the coloring member 31 at the backside portion of the light emitting element 21 (on the opposite side of the front lens 12) is formed so as to be larger than an area of a respective one of the side portions of the light emitting element 21. In this manner, the coloring member 31 is provided adjacent to the periphery of the light emission surface 21A of the light emitting element 21 except a portion at which the shaped 30 is formed. It is to be noted that this coloring member 31 is a member by which coloring with blue is applied, for example, whereas it is a matter of course that any other color may be employed as long as it works properly without being limited to blue.

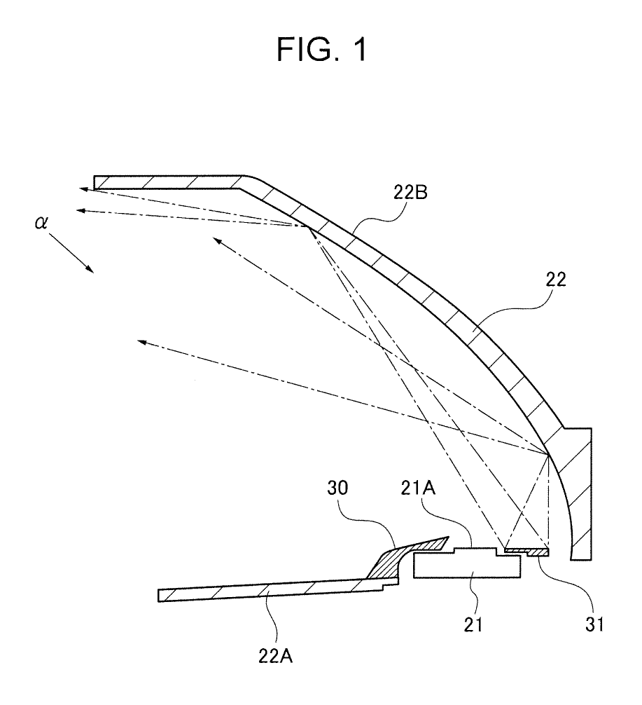

FIG. 1 is a view showing a cross section taken along the line I-I of FIG. 3. It is to be noted that in FIG. 1, the heat sink 23 is not shown. FIG. 1 shows, by means of the arrow in the figure, a fraction of an optical path when the light from the coloring member 31 is reflected on a light reflection surface of an interior surface of the curved portion 22B of the reflector 22 and then the reflected light is emitted to the side of the front lens 12 (the left side in the figure). In this manner, the coloring member 31 is disposed in proximity to the light emission surface 21A of the light emitting element 21, whereby the light that is reflected on the light reflection surface of the reflector 22 can be incident to the front lens 12 almost all over its region. Thus, in a case where the reflector 22 of the vehicle lighting device 10 is visually seen though the front lens 12, almost all over the region of the reflector 22 is seen blue. In addition, the coloring member 31 is mainly disposed at a backside portion of the light emitting element 21, whereby even if an area of the coloring member 31 is comparatively small, in a case where the reflector 22 of the vehicle lighting device 10 is visually seen, there is attained an effect of causing the coloring in the reflector 22, which is applied by means of the coloring member 31, to be more striking. The reason why such an effect is attained is that, in general, in a case where the lamp room 11 of the vehicle lighting device 10 is visually seen, the vehicle lighting device 10 is seen downward from its topside, depending on a human head position, as indicated by the arrow a in the figure; and therefore, the depth of the flat portion 22A can be seen more easily than that of the curved portion 22B of the reflector 22. The coloring member 31 thus formed can be disposed without shading an optical path for the light from the light emission surface 21A of the light emitting element 21, thus making it possible to eliminate an inconvenience of causing a decrease in quantity of emission of the light from the vehicle lighting device 10. It is to be noted that in FIG. 1, the light from the light emission surface 21A of the light emitting element 21 is not shown, whereas it is a matter of course that the light is reflected on the light reflection surface of the curved portion 22B of the reflector 22 and then the reflected light is emitted to the side of the front lens 12.

While, in the description of the first embodiment, the coloring member 31 is provided at a respective one of the side portions of the light emitting element 21, this coloring member 31 may be provided at only the backside portion of the light emitting element 21 (on the opposite side of the front lens 12) in place of being provided at such each side portion. This is because in such a case as well, the advantageous effects of the present invention can be sufficiently attained.

### Second Embodiment

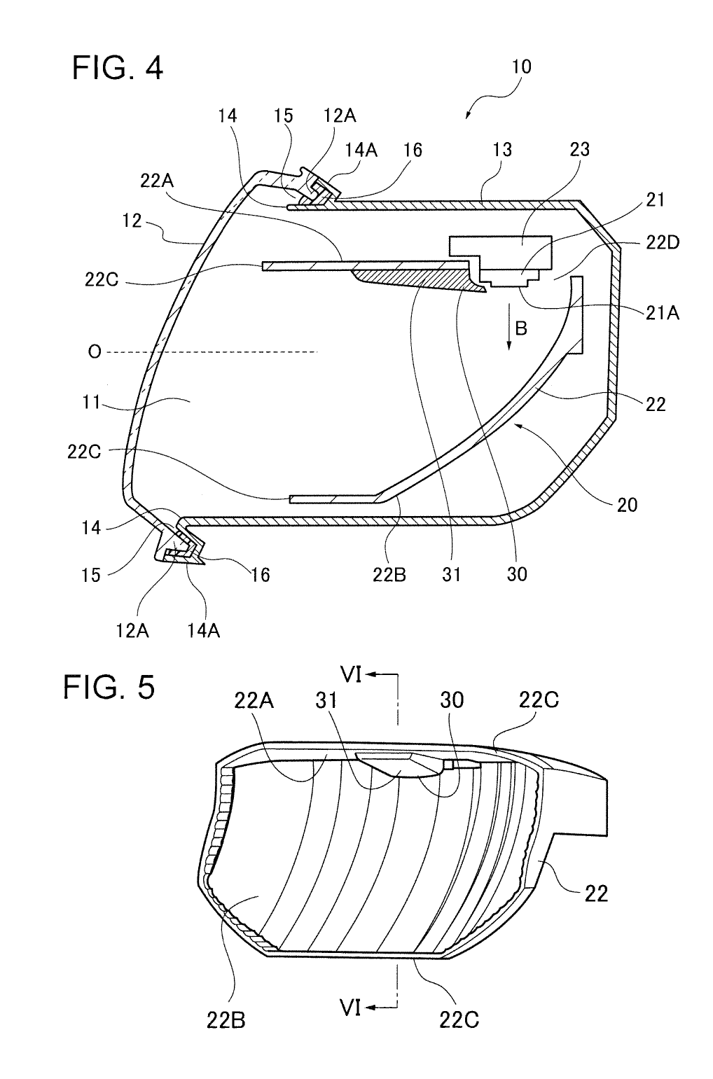

FIG. 4 is a sectional view schematically showing a vehicle lighting device 10 according to a second embodiment of the present invention, and is a view drawn in association with FIG. 2. A difference in comparison with the case of FIG. 2 lies in a headlamp 20 that is disposed in a lamp room 11 that is defined by a front lens 12 and a housing 13, and the headlamp 20 is disposed so as to be inverted topside down with respect to the headlamp 20 shown in the first embodiment. In other words, the light emitting element 21 of the headlamp 20 is disposed upward of the lamp room 11 so that a light emission surface 21A is oriented downward of the lamp room 11. In this case, as is the case with the first embodiment, the light emitting element 21 is disposed so that an emission direction (as indicated by the arrow B in the figure) of the light from the light emission surface 21A crosses an optical axis O of the front lens 12 without the light emission surface 21A being directly opposed to the front lens 12. In addition, as is the case with the first embodiment, the light emitting element 21 is mounted and disposed in a heat sink 23 that is mounted on a housing 13.

The reflector 22 of the headlamp 20 has: a flat portion 22A that is substantially flush with a surface on which the light emitting element 21 is to be disposed (equivalent to a mount surface of the heat sink 23); and a curved portion 22B that is formed on a lower side with respect to the surface on which the light emitting element 21 is to be disposed, and an opening 22C is formed and configured on the side of the front lens 12. FIG. 5 is a perspective view when the reflector 22 is seen from the side of the front lens 12, and it is evident that the reflector 22 is configured with the flat portion 22A and the curved portion 22B so as to be formed in the shape of a container having the opening 22C.

Turning to FIG. 4, as is the case with the first embodiment, an opening portion 22D that is adapted to expose the light emitting element 21 is provided at a site at which the light emitting element 21 is to be disposed, on the flat portion 22A of the reflector 22. In this manner, after the light emitting element 21 has been fixed to the housing 13 via the heat sink 23, the reflector 22 is fixed to the housing 13, thereby making it possible to dispose the light emitting element 21 at a predetermined site with respect to the reflector 22.

As is the case with the first embodiment, the curved portion 22B of the reflector 22 has a free surface that is obtained by combining a rotational parabola surface and a parabolic columnar surface or the like, for example, with each other, an interior surface that is opposed to the light emitting element 21 is provided with a light reflection surface to which light reflection processing is applied, and the light from the light emitting element 21 is reflected by means of the light reflection surface and then the reflected light is emitted to the side of the front lens 12.

In addition, in the flat portion 22A of the reflector 22, a shade 30 made of a material such as a resin or a metal, for example, is mounted and provided at the periphery of the opening portion 22D in which the light emitting element 21 is to be disposed and at the foreside portion of the light emitting element 21 (on the side of the front lens 12). The shade 30 is formed so as to cover the periphery of the light emitting element 21 up to a site just before reaching the light emission surface 21A, whereby in a case where the lamp room 11 of the vehicle lighting device 10 is seen through the front lens 12, the light emitting element 21 or its related wiring connected to the light emitting element 21 or the like is not directly visually seen. Further, a coloring member 31 is provided at a foreside portion of the light emitting element 21 (on the side of the front lens 12). In the second embodiment, the coloring member 31 is formed integrally with the shade 30, for example, and is configured with the shade 30 so as to apply coloring with blue together. Here, there exists a difference therebetween in that the coloring member 31 in the first embodiment is provided at least at the backside portion of the light emitting element 21 (on the opposite side of the front lens 12), whereas the coloring member 31 in the second embodiment is formed at least at the foreside portion of the light emitting element 21 (on the side of the front lens 12).

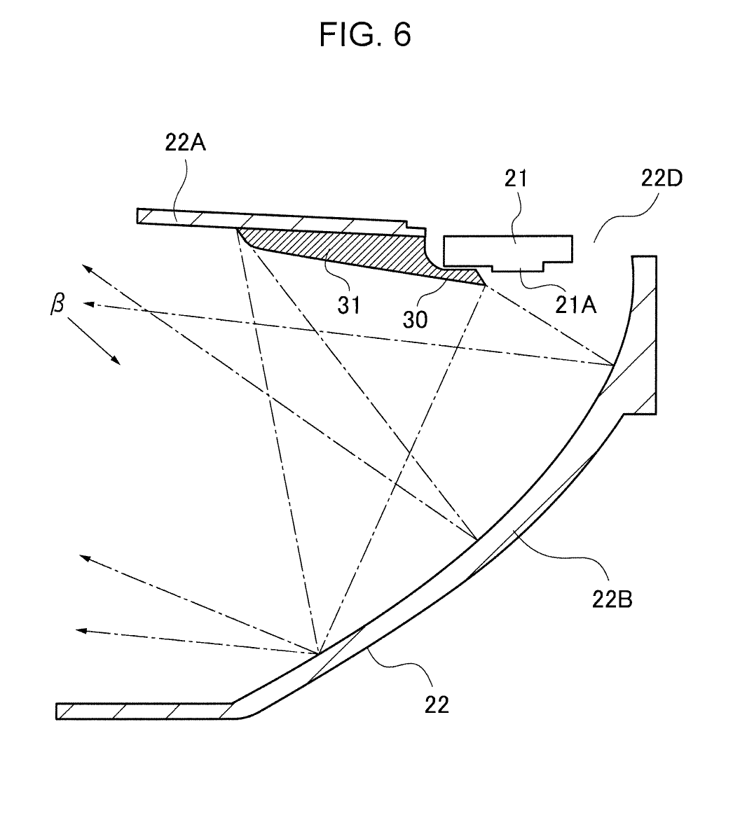

FIG. 6 is a sectional view taken along the line VI-VI of FIG. 5. It is to be noted that in FIG. 6, the heat sink 23 is not shown. FIG. 6 shows, by means of the arrow, a fraction of an optical path in which the light from the coloring member 31 is reflected on a light reflection surface that is formed in the curved portion 22B of the reflector 22 and then the reflected light is emitted to the side of the front lens 12. In this case, the coloring member 31 is disposed in proximity to the light emission surface 21A of the light emitting element 21, whereby the light that is reflected on the light reflection surface of the reflector 22 can be incident to the front lens 12 almost all over its region. Thus, in a case where the reflector 22 of the vehicle lighting device 10 is visually seen through the front lens 12, almost all over the region of the reflector 22 is seen blue. In addition, the coloring member 31 is disposed at the foreside portion of the light emitting element 21 (on the side of the front lens 12), whereby even if an area of the coloring member 31 is comparatively small, in a case where the lamp room 11 of the vehicle lighting device 10 is visually seen, there is attained an effect of causing the coloring in the reflector 22, which is applied by means of the coloring member 31, to be more striking. The reason why such an effect is attained is that, in general, in a case where the lamp room 11 of the vehicle lighting device 10 is visually seen, the vehicle lighting device 10 is seen downward from its topside, depending on a human head position, as indicated by the arrow β in FIG. 6; and therefore, the foreside portion of the light emitting element 21 can be visually seen over a wide region via the light reflection surface of the reflector 22. The coloring member 31 thus formed can be disposed without shading an optical path for the light from the light emission surface 21A of the light emitting element 21, thus making it possible to eliminate an inconvenience of causing an increase in quantity of emission of the light from the vehicle lighting device 10. It is to be noted that in the figure, the light from the light emission surface 21A of the light emitting element 21 is not shown, whereas it is a matter of course that the light is reflected on the light reflection surface of the reflector 22 and then the reflected light is emitted to the side of the front lens 12.

While, in the description of the second embodiment, the coloring member 31 is provided at the front side of the light emitting element 21 (on the side of the front lens 12), this coloring member may be provided at a respective one of the side portions of the light emitting element 21 and further at the backside portion of the light emitting element 21 (on the opposite side of the front lens 12) in place of being provided at such the front side. This is because in such a case as well, the advantageous effects of the present invention can be sufficiently attained. In addition, this coloring member 31 is shown by way of an example as the one by which coloring with blue is exhibited, whereas it is also a matter of course that any other color may be employed as long as it works properly without being limitative to such blue color.

As has been described hereinbefore, the vehicle lighting device 10 according to the present invention is capable of improving its appearance by exhibiting a predetermined color in the periphery of a light source when it is not lit, without shading the light from the light emitting element 21 at all.

The foregoing embodiments each have described the fact that the reflector 22 is made of the flat portion 22A and the curved portion 22B. However, the reflector 22 serves as a portion that has a main function of a reflector (a light reflection member) at its curved portion 22B. From the above descriptive matter, the reflector 22 may be made of only the curved portion 22B because the flat portion 22A is not always an indispensable member required.

In addition, the foregoing embodiments each have shown a configuration in which the shade 30 is mounted adjacent to the foreside portion of the light emitting element 21 (on the side of the front lens 12). However, it is a matter of course that this shade 30 may not be mounted.

Further, while, in the foregoing embodiments each, the light emitting element 21 has been employed as an example of a light source, it is a matter of course that the present invention is not always limited to the light emitting element 21.

While, in the foregoing embodiments each, the headlamp 20 has been shown as an example, it is a matter of course that the present invention can also be applied to any other lamp such as a tail lamp or a fog lamp, for example, without being limited thereto.

As described above, the present invention has been described using the exemplary embodiment, however, a technical scope of the present invention is not limited to a scope described in the above-described exemplary embodiment. It is obvious for those skilled in the art to add a variety of modifications or improvements to the above-described exemplary embodiment. It is also obvious from the scope of claims that the exemplary embodiment including the variety of modifications and improvements is also included in the technical scope of the present invention.

What is claimed is:

1. A vehicle lighting device comprising:
a reflector and a light source that are incorporated in a lamp room made of a housing and a front lens, wherein
the light source is disposed so that an emission direction of light from a light emission surface of the light source crosses an optical axis of the front lens,
the reflector is disposed on one side with respect to a surface on which the light source is to be disposed, the reflector being configured with a curved portion that is adapted to reflect the light from the light source to a side of the front lens, and
a coloring member is disposed so as to be adjacent to at least a part of a periphery of the light emission surface of the light source.

2. The vehicle lighting device according to claim 1, wherein
the light source is disposed upward of the reflector in a state in which the vehicle lighting device is mounted on a vehicle, and
the coloring member is disposed so as to be adjacent to the side of the front lens with respect to at least the light emission surface of the light source.

3. The vehicle lighting device according to claim 1, wherein
the light source is disposed downward of the reflector in a state in which the vehicle lighting device is mounted on a vehicle, and
the coloring member is disposed so as to be adjacent to an opposite side of the front lens with respect to at least the light emission surface of the light source.
